(19) United States
(12) Patent Application Publication
(10) Pub. No.: US 2007/0098078 A1
(43) Pub. Date: May 3, 2007

(54) Method and apparatus for video encoding/decoding

(75) Inventors: So-young Kim, Yongin-si (KR); Jeong-hoon Park, Seoul (KR); Sang-rae Lee, Suwon-si (KR); Jae-chool Lee, Suwon-si (KR); Yu-mi Sohn, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS., LTD.

(21) Appl. No.: 11/591,618

(22) Filed: Nov. 2, 2006

(30) Foreign Application Priority Data
Nov. 2, 2005 (KR) 10-2005-0104362

(51) Int. Cl. H04N 11/04; H04N 7/12

(52) U.S. Cl. 375/240.24; 375/240.26

(57) ABSTRACT

A method and apparatus for video encoding/decoding provides a macroblock used as a unit of video division and encoding formed in various sizes, positions, and shapes to improve compression efficiency according to video characteristics. The video encoding method, divides a video into macroblocks while moving macroblocks in each row and/or each column by a predetermined-size pixel and each of the macroblocks is encoded. A video may also be divided into macroblocks at a position spaced apart from a corner of the video by a predetermined offset and each of the macroblocks is encoded. Encoding may also be performed on each sub-block and sub-blocks having the same prediction mode may be grouped into a macroblock having another form.

### CROSS-REFERENCE TO RELATED PATENT APPLICATION

This application claims priority from Korean Patent Application No. 10-2005-0104362, filed on Nov. 2, 2005, in the Korean Intellectual Property Office, the disclosure of which is incorporated herein in its entirety by reference.

### BACKGROUND OF THE INVENTION

1. Field of the Invention

The present invention relates to video compression encoding, and more particularly, to a method and apparatus for video encoding/decoding using a macroblock as an encoding unit in various sizes, positions, and shapes, and encoding in macroblock units.

2. Description of the Related Art

In well-known video compression standards such as moving picture expert group (MPEG) MPEG-1, MPEG-2, MPEG-4 Visual, H.261, H.263, and H.264, a frame is generally divided into a plurality of macroblocks. A prediction process is performed on each of the macroblocks to obtain a prediction block and a difference between the original block and the prediction block is transformed and quantized for video compression.

There are two types of prediction, i.e., intraprediction and interprediction. In intraprediction, a current block is predicted using data of neighboring blocks of the current block in a current frame, which have already been encoded and reconstructed. In interprediction, a prediction block of the current block is generated from at least one previously encoded video frame using block-based motion compensation.

After the cost of the prediction block predicted in an intraprediction mode or an interprediction mode is calculated, a mode having the smallest cost is selected for video encoding, thereby improving compression efficiency.

FIG. 1 illustrates an input video that is divided into 16×16 macroblocks, each of which is used as an encoding unit according to the prior art.

Referring to FIG. 1, the input video is divided into 16×16 macroblocks sequentially from its top-left pixel and encoding is performed on each of the 16×16 macroblocks. In other words, according to the prior art, the input video is divided into macroblocks having fixed positions for encoding.

FIG. 2 illustrates images resulting from intraprediction or interprediction with respect to each of 4×4 sub-blocks formed from 16×16 macroblocks according to the prior art. In FIG. 2, “0” indicates a 4×4 intra block and “1” indicates a 4×4 inter block.

According to the prior art, a selection is made as to whether to perform a prediction process in an intra mode or an inter mode for each macroblock, thereby preventing the number of syntaxes indicating encoding information of each macroblock from increasing. However, all sub-blocks included in the same macroblock are not predicted in the same mode. This is because macroblocks have fixed positions and the input video is divided into the macroblocks regardless of the characteristics of the input video.

In other words, as illustrated in FIG. 2, when a macroblock is divided into 4×4 sub-blocks and each of the 4×4 sub-blocks is predicted, a single macroblock may include both intrapredicted sub-blocks and interpredicted sub-blocks. In this case, information of the intrapredicted sub-blocks and the interpredicted sub-blocks should be included in an encoded bitstream for video encoding, resulting in degradation in compression efficiency.

Therefore, a video encoding method having improved compression efficiency is required to overcome a limited transmission bandwidth and provide high-quality video to users.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non- limiting embodiment of the present invention may not overcome any of the problems described above.

The present invention provides a method and apparatus for video encoding/decoding, in which a macroblock used as a video division and encoding unit is formed in various sizes, positions, and shapes to improve compression efficiency according to video characteristics.

According to one aspect of the present invention, there is provided a video encoding method including dividing an input video while moving macroblocks in each row and/or each column by a predetermined-size pixel, encoding the video divided by the macroblocks, comparing costs of the encoded video according to moving positions of the macroblocks and determining an optimal moving position having the smallest cost for the macroblocks in each row and/or each column, and storing information about the optimal moving position for the macroblocks in each row and/or each column in a bitstream of the encoded video.

According to another aspect of the present invention, there is provided a video encoding method including dividing an input video into macroblocks at a position spaced apart from a corner of the input video by a predetermined offset, encoding the input video divided by the macroblocks spaced apart from the input video by the predetermined offset, comparing costs of the encoded video according to values of the predetermined offset and determining an optimal offset having the smallest cost, and storing information about the optimal offset in a bitstream of the encoded video.

According to still another aspect of the present invention, there is provided a video encoding method including dividing an input video into a plurality of predetermined-size blocks and performing interprediction and intraprediction on each of the blocks to determine a prediction mode for each of the blocks, grouping the blocks into at least one block group based on the prediction modes of the blocks, and generating group map information including information about the prediction modes of the grouped blocks included in the block groups.

According to yet another aspect of the present invention, there is provided a video encoder including a video division unit, an encoding unit, an optimal moving position determination unit, and a position storage unit. The video division unit divides an input video while moving macroblocks in each row and/or each column by a predetermined-size pixel. The encoding unit encodes the video divided by the macroblocks. The optimal moving position determination unit compares costs of the encoded video according to moving positions of the macroblocks and determines an optimal moving position having the smallest cost for the macroblocks in each row and/or each column. The position storage unit stores information about the optimal moving position for the macroblocks in each row and/or each column in a bitstream of the encoded video.

According to yet another aspect of the present invention, there is provided a video encoder including an offset video division unit, an encoding unit, an optimal offset determination unit, and an offset storage unit. The offset video division unit divides an input video into macroblocks at a position spaced apart from a corner of the input video by a predetermined offset. The encoding unit encodes the video divided by the macroblocks spaced apart from the input video by the predetermined offset. The optimal offset determination unit compares costs of the encoded video according to values of the predetermined offset and determines an optimal offset having the smallest cost. The offset storage unit stores information about the optimal offset in a bitstream of the encoded video.

According to yet another aspect of the present invention, there is provided a video encoder including an encoding unit, a grouping unit, and a group map information generation unit. The encoding unit divides an input video into a plurality of predetermined-size blocks and performes interprediction and intraprediction on each of the blocks to determine a prediction mode for each of the blocks. The grouping unit groups the blocks into at least one block group based on the prediction modes of the blocks. The group map information generation unit generates group map information including information about the prediction modes of the grouped blocks included in the block groups.

According to yet another aspect of the present invention, there is provided a video decoding method including receiving a bitstream including video data obtained by encoding a video divided while moving macroblocks in each row and/or each column by a predetermined pixel and moving position information of the macroblocks in each row and/or each column, decoding the video using the received video data, and reconstructing the decoded video by moving the macroblocks in each row and/or each column according to the received moving position information.

According to yet another aspect of the present invention, there is provided a video decoding method including receiving a bitstream including video data obtained by encoding a video divided into macroblocks at a position spaced apart from a corner of the video by a predetermined offset and information about the predetermined offset, decoding the video using the received video data, reconstructing the decoded video by moving the decoded video according to the information about the predetermined offset.

According to yet another aspect of the present invention, there is provided a video decoding method including receiving a bitstream including video data obtained by encoding a video through interprediction or intraprediction with respect to each of a plurality of predetermined-size blocks and group information including information about the prediction modes of blocks included in a block group according to the prediction modes of the blocks and decoding the blocks according to the prediction modes of the blocks of the block group using the received group map information.

According to yet another aspect of the present invention, there is provided a video decoder including a receiving unit, a decoding unit, and a video reconstruction unit. The receiving unit receives a bitstream including video data obtained by encoding a video divided while moving macroblocks in each row and/or each column by a predetermined pixel and moving position information of the macroblocks in each row and/or each column. The decoding unit decodes the video using the received video data. The video reconstruction unit reconstructs the decoded video by moving the macroblocks in each row and/or each column according to the received moving position information.

According to yet another aspect of the present invention, there is provided a video decoder including a receiving unit, a decoding unit, and a video reconstruction unit. The receiving unit receives a bitstream including video data obtained by encoding a video divided into macroblocks at a position spaced apart from a corner of the video by a predetermined offset and information about the predetermined offset. The decoding unit decodes the video using the received video data. The video reconstruction unit reconstructs the decoded video by moving the decoded video according to the information about the predetermined offset.

According to yet another aspect of the present invention, there is provided a video decoder including a receiving unit and a decoding unit. The receiving unit receives a bitstream including video data obtained by encoding a video through interprediction or intraprediction with respect to each of a plurality of predetermined-size blocks and group information including information about the prediction modes of blocks included in a block group according to the prediction modes of the blocks. The decoding unit decodes the blocks according to the prediction modes of the blocks of the block group using the received group map information.

### BRIEF DESCRIPTION OF THE DRAWINGS

The above and other aspects of the present invention will become more apparent by describing in detail exemplary embodiments thereof with reference to the attached drawings in which:

FIG. 1 illustrates an input video that is divided into 16×16 macroblock, each of which being used as an encoding unit according to the prior art;

FIG. 2 illustrates an image resulting from intraprediction or interprediction with respect to each of 4×4 sub-blocks that are divided from 16×16 macroblocks according to the prior art;

FIG. 3 is a block diagram of a video encoder according to a first exemplary embodiment of the present invention;

FIG. 4 is a diagram illustrating the operation of a video division unit of FIG. 3;

FIG. 5 is a detailed block diagram of an encoding unit of FIG. 3;

FIG. 6 is a flowchart of a video encoding method according to the first exemplary embodiment of the present invention;

FIG. 7 is a block diagram of a video encoder according to a second exemplary embodiment of the present invention;

FIG. 8 is a diagram illustrating the operation of an offset video division unit of FIG. 7;

FIG. 9 is a flowchart of a video encoding method according to the second exemplary embodiment of the present invention;

FIG. 10 is a block diagram of a video encoder according to a third exemplary embodiment of the present invention;

FIG. 11 is a diagram illustrating the operation of the video encoder according to the third exemplary embodiment of the present invention;

FIG. 12 is a flowchart of a video encoding method according to the third exemplary embodiment of the present invention;

FIG. 13 is a block diagram of a video decoder according to an exemplary embodiment of the present invention; and

FIG. 14 is a flowchart of a video decoding method according to the exemplary embodiment of the present invention.

### DETAILED DESCRIPTION OF THE EXEMPLARY EMBODIMENTS

Hereinafter, exemplary embodiments of the present invention will be described in detail with reference to the accompanying drawings.

According to exemplary embodiments of the present invention, an encoding mode in which a macroblock formed in various sizes, positions, and shapes used as a video division and encoding unit to improve compression efficiency is added to a conventional encoding method in which an input video is divided into macroblocks (generally 16×16 macroblocks) having the same size, position, and shape, and encoding is performed for each of the macroblocks. An encoding method according to exemplary embodiments of the present invention may be used as a new encoding mode in addition to the conventional encoding method.

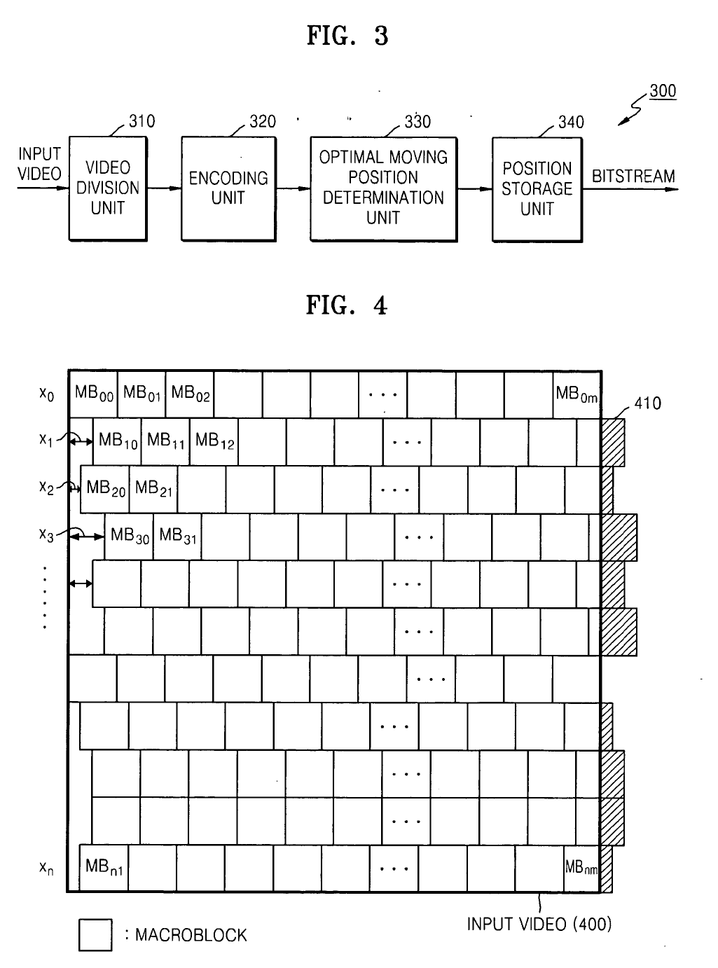

FIG. 3 is a block diagram of a video encoder 300 according to a first exemplary embodiment of the present invention.

The video encoder 300 divides an input video while moving macroblocks in each row and/or each column by a predetermined-size pixel and encodes the input video that is divided into the moved macroblocks.

Referring to FIG. 3, the video encoder 300 may include a video division unit 310, an encoding unit 320, an optimal moving position determination unit 330, and a position storage unit 340.

The video division unit 310 divides the input video while moving macroblocks in each row and/or each column by a predetermined-size pixel. The video division unit 310 divides the input video while changing the moving size of the macroblocks.

FIG. 4 is a diagram illustrating the operation of the video division unit 310 of FIG. 3. In FIG. 4, it is assumed that an input video 400 includes m macroblocks in each row and n macroblocks in each column.

Referring to FIG. 4, the video division unit 310 divides the input video 400 into macroblocks MB₀₀, MB₀₁, . . . , MBₙₘ. Unlike in the conventional encoding method in which the input video 400 is divided sequentially from its top-left pixel, the video division unit 310 divides the input video 400 while moving macroblocks in each row by a predetermined-size pixel. For example, the video division unit 310 divides the input video 400 while horizontally moving macroblocks MB₀₀, MB₀₁, . . . , MB₀ₘ in the first row by a pixel x₀. The video division unit 310 also divides the input video 400 while horizontally moving macroblocks MB₁₀, MB₁₁, . . . , MB₁ₘ in the second row by a pixel x₁. In this way, the video division unit 310 divides an input video while horizontally moving macroblocks in an a^{th} row by a pixel xₐ₋₁.

When the video division unit 310 horizontally moves macroblocks in a predetermined row, a portion 410 that is not included in the input video 400 may be generated as illustrated in FIG. 4. The portion 410 is formed by extrapolating neighboring pixels thereof in the input video 400. When the video division unit 310 horizontally moves macroblocks in a predetermined row, a portion of the original input video, which is not included in the moved macroblocks, is encoded using raw data, i.e., original pixels, or encoded in a skip mode.

Although macroblocks in each row are horizontally moved in FIG. 4, the video division unit 310 may also vertically move macroblocks in each column by a predetermined-size pixel for video division.

Referring back to FIG. 3, the macroblocks divided by the video division unit 310 are sequentially input to the encoding unit 320 according to a raster scan order and the encoding unit 320 encodes each of the macroblocks through interprediction and intraprediction.

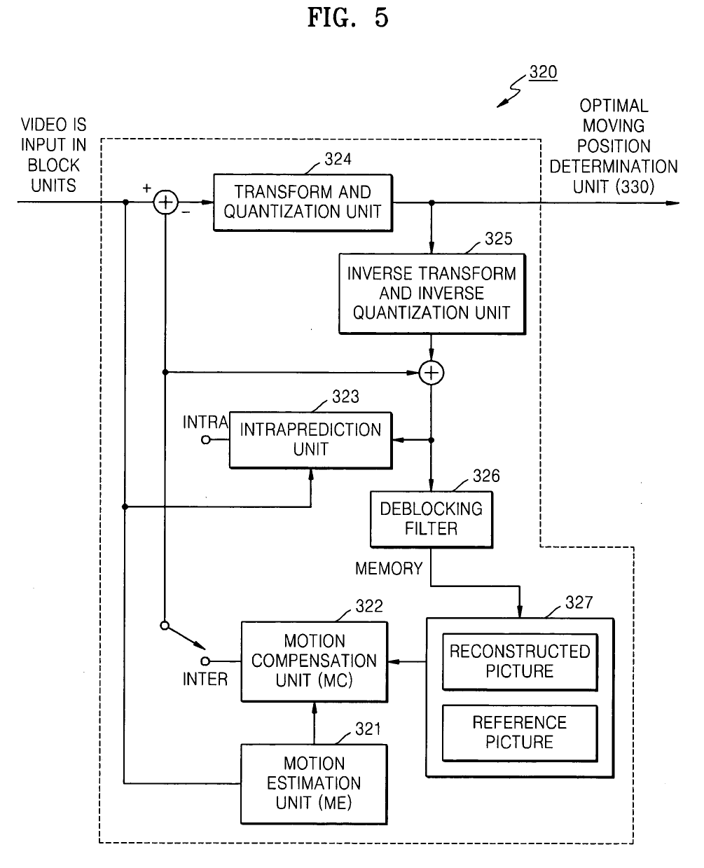

FIG. 5 is a detailed block diagram of the encoding unit 320 of FIG. 3.

Referring to FIG. 5, the encoding unit 320 may include a motion estimation unit 321, a motion compensation unit 322, an intraprediction unit 323, a transform and quantization unit 324, an inverse transform and inverse quantization unit 325, a deblocking filter 326, and a memory 327.

The motion estimation unit 321 and the motion compensation unit 322 perform interprediction on each of the macroblocks. Interprediction predicts a current macroblock using a reference picture that has been decoded, deblocking-filtered, and stored in a buffer. In other words, interprediction is performed using information between pictures. The intraprediction unit 323 performs intraprediction on each of the macroblocks. Intraprediction predicts a current block using pixel data of a neighboring block of the current block within an encoded and decoded picture.

A reference picture or a reconstructed picture is stored in the memory 327 for use in the interprediction of a next picture. The transform and quantization unit 324 transforms and quantizes a residue between interpredicted or intrapredicted video data and the original video data and outputs a transform block including quantized transform coefficients.

The encoding unit 320 is not limited to the configuration illustrated in FIG. 5 and an encoding unit according to various video compression standards may be used as the encoding unit 320.

Referring back to FIG. 3, a video resulting from intraprediction or interprediction with respect to the macroblocks in each row and/or column, moved by the encoding unit 320, is input to the optimal moving position determination unit 330.

The optimal moving position determination unit 330 calculates the cost of the predicted video according to the moving position of the macroblocks in each row and/or each column and determines the optimal moving position of the macroblocks having the smallest cost. For example, in FIG. 4, the optimal moving position determination unit 330 compares the costs of the predicted video according to horizontal moving sizes x₁, x₂, . . . , Xₙ of the macroblocks and determines the optimal moving position of the macroblocks having the smallest cost. In other words, the optimal moving position determination unit 330 determines the optimal moving position of the macroblocks in each row and/or each column, which can be used to determine the optimal macroblock mode and motion vector. Here, cost calculation may be performed using various methods such as a sum of absolute difference (SAD) cost function, a sum of absolute transformed difference (SATD) cost function, a sum of squares difference (SSD) cost function, a mean of absolute difference (MAD) cost function, and a Lagrange cost function.

The position storage unit 340 stores the determined optimal moving position of the macroblocks in each row and/or each column, together with an encoding mode of each of the macroblocks and residual information in the encoded bitstream. For example, when the determined optimal moving positions of the macroblocks are x₁′, x₂′, . . . , xₘ′, they are stored in a header of the bitstream.

Encoded video data including information about the optimal moving position according to the first exemplary embodiment of the present invention undergoes variable length coding or context adaptive binary arithmetic coding (CABAC) through an entropy encoding unit (not shown) and is output as a final bitstream.

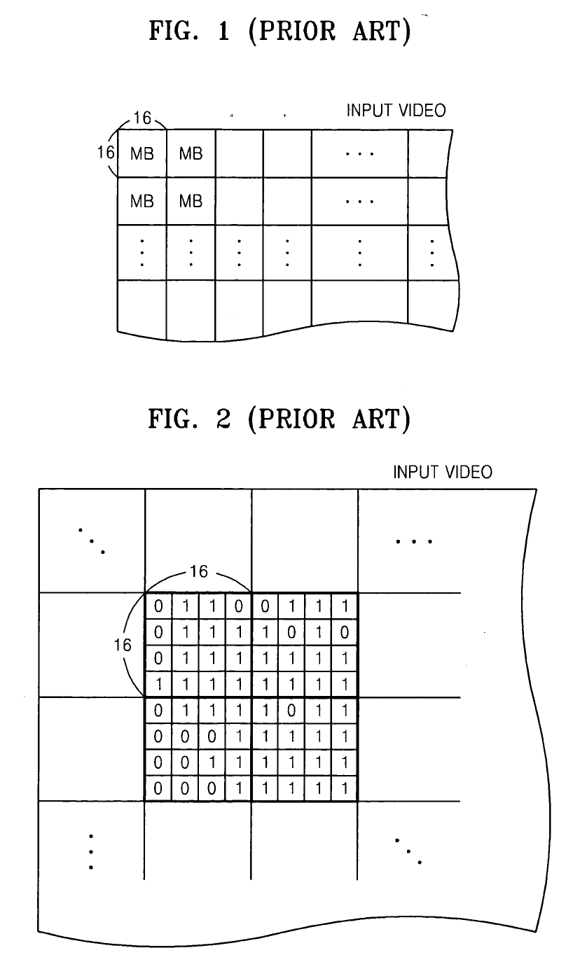

The video encoder 300 according to the first exemplary embodiment of the present invention may also compare the cost of a predicted video obtained through prediction with respect to macroblocks moved by a predetermined-size pixel and the cost of a predicted video obtained through prediction with respect to macroblocks divided without being moved as illustrated in FIG. 1 and determine an encoding mode having the smaller cost as a final encoding mode.

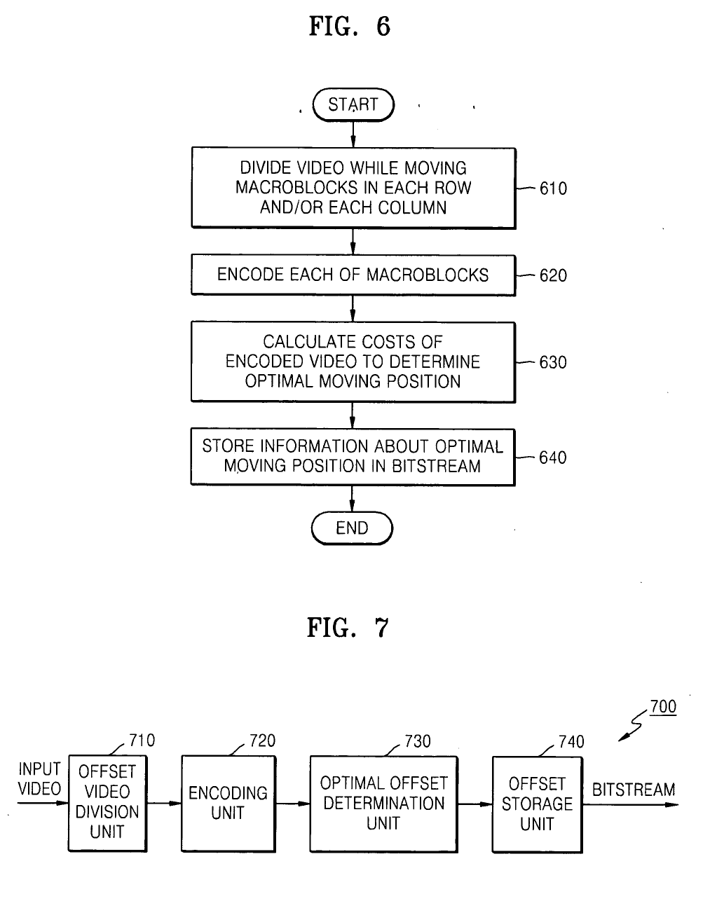

FIG. 6 is a flowchart of a video encoding method according to the first exemplary embodiment of the present invention.

Referring to FIG. 6, in operation 610, an input video is divided while moving macroblocks in each row and/or each column by a predetermined-size pixel.

In operation 620, the divided video is encoded through interprediction and intraprediction with respect to each of the macroblocks.

In operation 630, the costs of the encoded video according to the moving positions of the macroblocks are compared and the optimal moving position having the smallest cost is determined.

In operation 640, macroblock mode information, residual information, and optimal moving position information for macroblocks in each row and/or each column are stored in a bitstream of the encoded video.

The video encoder 300 and the video encoding method according to the first exemplary embodiment of the present invention reduce the size of a motion vector to be encoded by moving macroblocks in each row and/or each column when encoding a video including a moving object or a fine change, thereby improving compression and prediction efficiency.

FIG. 7 is a block diagram of a video encoder 700 according to a second exemplary embodiment of the present invention.

Referring to FIG. 7, the video encoder 700 may include an offset video division unit 710, an encoding unit 720, an optimal offset determination unit 730, and an offset storage unit 740.

The offset video division unit 710 starts dividing the input video into macroblocks at a position spaced apart from a corner of the input video by a predetermined offset. Unlike the conventional encoding method which starts dividing the input video into macroblocks at the top-left corner of the input video, the offset video division unit 710 starts dividing the input video into macroblocks at a position spaced apart from a corner of the input video.

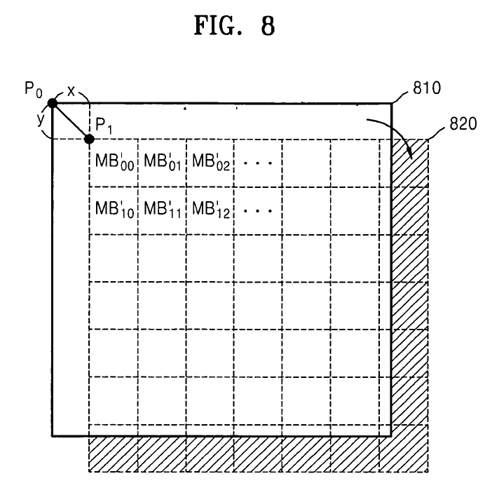

FIG. 8 is a diagram illustrating the operation of the offset video division unit 710 of FIG. 7.

Referring to FIG. 8, the offset video division unit 710 starts dividing the input video at a position P₁ spaced apart from the top-left corner P₀ of an input video 810 by a predetermined offset (x, y). In this case, a spaced video 820 formed at a position spaced by the predetermined offset from the input video 810 includes a portion 820 that is not included in the input video 810. Pixels of the portion 820 are formed by symmetrizing the input video 810 or extrapolating their neighboring pixels in the input video 810. In other words, the portion 820 that is not included in the input video 810 among macroblocks spaced apart from the input video 810 by the predetermined offset (x, y) may be formed by symmetrizing a portion of the input video 810, which is not included in the spaced macroblocks, or extrapolating neighboring pixels thereof in the input video 810.

Referring back to FIG. 7, the macroblocks divided by the offset video division unit 710 are input to the encoding unit 720 and the encoding unit 720 encodes each of the macroblocks through interprediction and intraprediction with respect to each of the macroblocks. The configuration and operation of the encoding unit 720 of FIG. 7 are similar to the encoding unit 320 of FIG. 3 and a description thereof will not be provided.

A video resulting from the encoding of the macroblocks spaced apart from the input video 810 by the predetermined offset in the video encoding unit 720 is input to the optimal offset determination unit 730.

The optimal offset determination unit 730 compares the costs of the encoded video according to values of the predetermined offset and determines the optimal offset having the smallest cost. In other words, the optimal offset determination unit 730 compares the costs of the encoded video to determine a value of the predetermined offset that minimizes the cost of the encoded video. The offset storage unit 740 stores information about the determined optimal offset in the bitstream of the encoded video.

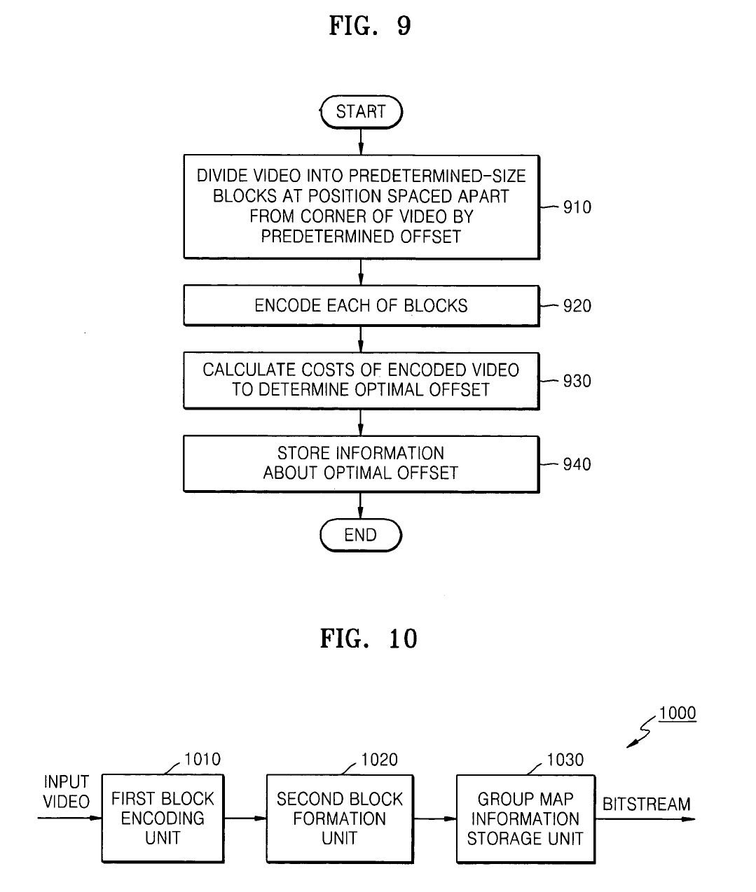

FIG. 9 is a flowchart illustrating a video encoding method according to the second exemplary embodiment of the present invention.

Referring to FIG. 9, in operation 910, the input video is divided into macroblocks at a position spaced apart from a corner of the input video by a predetermined offset.

In operation 920, the video divided by the macroblocks is encoded through interprediction and intraprediction with respect to each of the macroblocks.

In operation 930, the costs of the encoded video according to values of the predetermined offset are compared and the optimal offset having the smallest cost is determined.

In operation 940, information about the determined optimal offset is stored in the bitstream of the encoded video.

The video encoder 700 and the video encoding method according to the second exemplary embodiment of the present invention reduce the size of a motion vector to be encoded when interpredicting a video including a moving object or a fine change, thereby improving compression and prediction efficiency.

FIG. 10 is a block diagram of a video encoder 1000 according to a third exemplary embodiment of the present invention.

The video encoder 1000 and a video encoding method according to the third exemplary embodiment of the present invention perform interprediction or intraprediction in units of a predetermined-size block that is smaller than the macroblock and reconstruct the macroblock according to the number of prediction modes of the predetermined-size blocks.

Referring to FIG. 10, the video encoder 1000 may include a first block encoding unit 1010, a second block formation unit 1020, and a group map information storage unit 1030.

The first block encoding unit 1010 divides a video into a plurality of predetermined-size first blocks and performs interprediction and intraprediction on each of the first blocks to determine a prediction mode for each of the first blocks. In other words, the first block encoding unit 1010 calculates the costs of the interpredicted video and the intrapredicted video for each of the first blocks and determines a prediction mode having the smallest cost as a final prediction mode for each of the first blocks.

The second block formation unit 1020 groups the first blocks into at least one block group based on the determined prediction modes of the first blocks. That is, the second block formation unit 1020 forms a second block by grouping the first blocks having the same prediction mode according to the number of first blocks. Here, the second block formation unit 1020 groups as many adjacent first blocks having the same prediction mode as possible into the second block. The second block may have various forms such as a square or a rectangle.

The group map storage unit 1030 stores group map information including the size and shape of the second block and a prediction mode of each of the first blocks included in the second block. For example, when the second blocks are grouped into a slice, the group map information is stored in slice information.

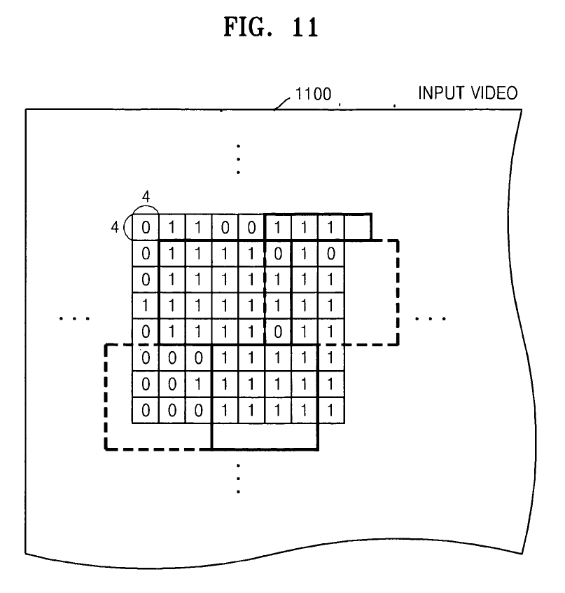

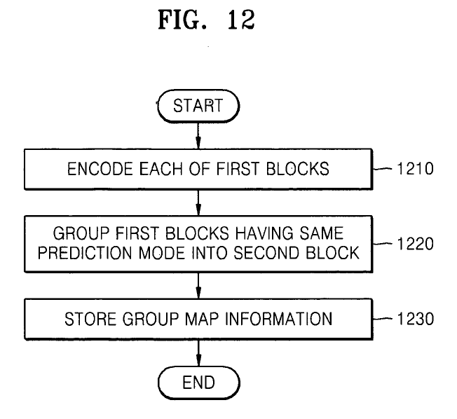

FIG. 11 is a diagram illustrating the operation of the video encoder 1000 according to the third exemplary embodiment of the present invention.

Referring to FIG. 11, the first block encoding unit 1010 divides the input video into predetermined-size first blocks, e.g., 4×4 sub-blocks, and performs intraprediction and interprediction on each of the 4×4 sub-blocks to determine a prediction mode for each of the 4×4 sub-blocks. In FIG. 11, “0” indicates a 4×4 intra block and “1” indicates a 4×4 inter block.

The second block formation unit 1020 groups the first blocks having the same prediction mode into a second block according to the number of first blocks using the determined prediction modes of the first blocks. As mentioned above, the second block formation unit 1020 groups as many adjacent first blocks having the same prediction mode as possible into the second block. For example, 4×4 sub-blocks having an interprediction mode are included in a second block 1100 of FIG. 11. As such, the second block formation unit 1020 forms the second block including as many adjacent first blocks having the same prediction mode as possible.

FIG. 12 is a flowchart of a video encoding method according to the third exemplary embodiment of the present invention.

Referring to FIG. 12, in operation 1210, an input video is divided into a plurality of predetermined-size first blocks and interprediction and intraprediction are performed on each of the first blocks to determine a prediction mode for each of the first blocks.

In operation 1220, the first blocks having the same prediction mode are grouped into a second block according to the number of first blocks using the determined prediction modes of the first blocks.

In operation 1230, group map information of the first blocks included in the second block is stored.

The video encoder 1000 and the video encoding method according to the third exemplary embodiment of the present invention can reduce the number of syntaxes to be transmitted by changing the shape of a macroblock such that the macroblock includes as many sub-blocks having the same prediction mode as possible. In other words, when there are many sub-blocks having the same prediction mode, the number of syntaxes indicating a prediction mode of each of the sub-blocks can be reduced, thereby improving compression efficiency.

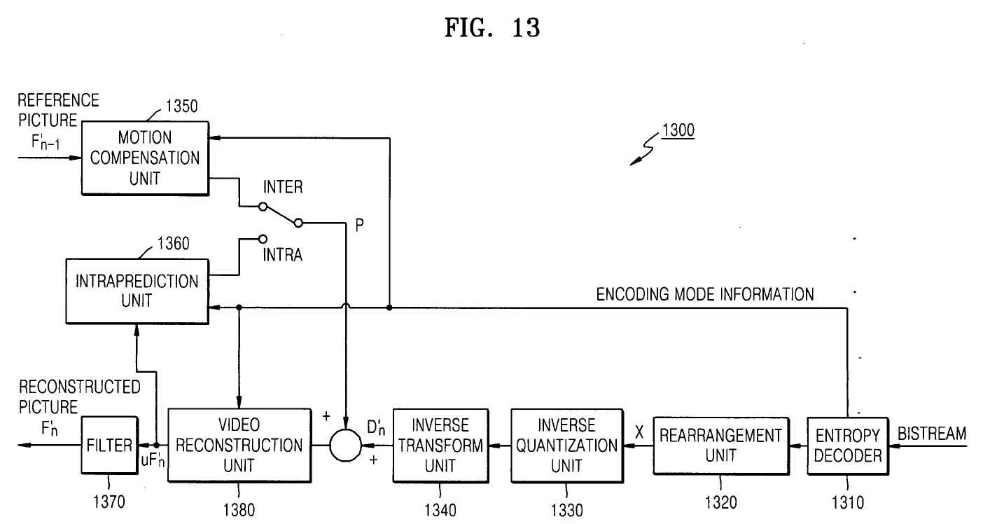

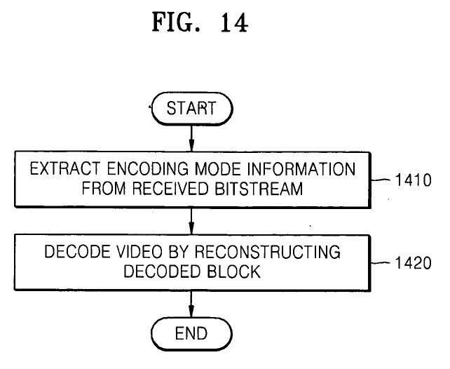

FIG. 13 is a block diagram of a video decoder 1300 according to an exemplary embodiment of the present invention, and FIG. 14 is a flowchart of a video decoding method according to the exemplary embodiment the present invention.

Referring to FIG. 13, the video decoder 1300 may include an entropy decoder 1310, a rearrangement unit 1320, an inverse quantization unit 1330, an inverse transform unit 1340, a motion compensation unit 1350, an intraprediction unit 1360, a filter 1370, and a video reconstruction unit 1380.

The entropy decoder 1310 and the rearrangement unit 1320 receive a compressed bitstream and perform entropy decoding to generate quantized coefficients. The entropy decoder 1310 also extracts encoding mode information included in the compressed bitstream and transmits the extracted encoding mode information to the motion compensation unit 1350 and the intraprediction unit 1360. The inverse quantization unit 1330 and the inverse transform unit 1340 perform inverse quantization and inverse transform on the quantized coefficients to extract transform encoding coefficients and motion vector information.

The motion compensation unit 1350 and the intraprediction unit 1360 generate a prediction block according to the type of an encoded picture using decoded header information. A residue D′ₙ, is added to the prediction block, thereby generating uF′ₙ. uF′ₙ passes through the filter 1370, thereby generating a reconstructed picture F′ₙ.

The video decoder 1300 includes the video reconstruction unit 1380 to decode a bitstream encoded according to the video encoding methods according to the exemplary embodiments of the present invention. FIG. 14 is a flowchart of a video decoding method according to the exemplary embodiment of the present invention.

In operation 1410, encoding mode information is extracted from a received bitstream to determine an encoding mode of the bitstream to be decoded.

In operation 1420, a decoding unit including the motion compensation unit 1350 and the intraprediction unit 1360 decodes a video using video data included in the received bitstream and the video reconstruction unit 1380 reconstructs the decoded video according to an encoding method of the exemplary embodiments of the present invention. More specifically, when the received bitstream is encoded by the encoding method according to the first exemplary embodiment of the present invention, the video reconstruction unit 1380 reconstructs the decoded video by moving macroblocks in each row and/or each column, which are predicted by the motion compensation unit 1350 and the intraprediction unit 1360. A bitstream encoded according to the first exemplary embodiment of the present invention includes video data obtained by encoding a video divided while moving macroblocks in each row and/or each column by a predetermined pixel and moving position information of the macroblocks in each row and/or each column. A decoding unit including the motion compensation unit 1350 and the intraprediction unit 1360 decodes the video using the video data and the video reconstruction unit 1380 moves the decoded video according to the moving position information extracted from the received bitstream for reconstruction.

A bitstream encoded according to the second exemplary embodiment of the present invention includes video data obtained by encoding a video divided into macroblocks at a position spaced apart from a corner of the video by a predetermined offset and offset information. When the video is reconstructed from the bitstream encoded according to the second exemplary embodiment of the present invention, the video reconstruction unit 1380 reconstructs the video by moving the decoded video according to the offset information included in the bitstream. In other words, the video data included in the bitstream received by a predetermined receiver (not shown) is interprediction decoded or intraprediction decoded and the video reconstruction unit 1380 reconstructs the video by moving the decoded video back to the original position according to the offset information included in the bitstream.

A bitstream encoded according to the third exemplary embodiment of the present invention includes video data encoded through interprediction or intraprediction with respect to each of a plurality of predetermined-size blocks and group map information including information about prediction modes of the blocks grouped according to the prediction modes of the blocks.

To reconstruct the video from the bitstream, the receiver receives the bitstream. A decoding unit including the motion compensation unit 1350 and the intraprediction unit 1360 performs intraprediction or interprediction on each of the blocks using the video data and a prediction mode of each of the blocks of the group map information, thereby decoding the blocks.

As described above, according to the exemplary embodiments of the present invention, by varying the conventionally fixed position, size, and shape of macroblocks, compression and prediction efficiency in video encoding can be improved according to video characteristics.

Meanwhile, the present invention can also be embodied as computer-readable code stored in a computer-readable recording medium. The computer-readable recording medium is any data storage device that can store data which can be thereafter read by a computer system. Examples of the computer-readable recording medium include, but are not limited to, read-only memory (ROM), random-access memory (RAM), CD-ROMs, magnetic tapes, floppy disks, optical data storage devices, and carrier waves (e.g., transmission over the Internet). The computer-readable recording medium can also be distributed over network coupled computer systems so that the computer-readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A video encoding method comprising:
dividing an input video while moving macroblocks in at least one of each row and each column by a predetermined-size pixel;
encoding the video divided by the macroblocks;
comparing costs of the encoded video according to moving positions of the macroblocks;
determining an optimal moving position having a smallest cost for the macroblocks in the at least one of each row and each column; and
storing information about the optimal moving position for the macroblocks in the at least one of each row and each column in a bitstream of the encoded video.

2. The video encoding method of claim 1, wherein the macroblocks in each row are horizontally moved by the predetermined-size pixel and the macroblocks in each column are vertically moved by the predetermined-size pixel.

3. The video encoding method of claim 1, further comprising comparing the cost of the video encoded using the moved macroblocks and the cost of a video encoded without moving the macroblocks and determining an encoding mode having the smaller cost as a final encoding mode.

4. A video encoding method comprising:
dividing an input video into macroblocks at a position spaced apart from a corner of the input video by a predetermined offset;
encoding the input video divided by the macroblocks spaced apart from the input video by the predetermined offset;
comparing costs of the encoded video according to values of the predetermined offset and determining an optimal offset having a smallest cost; and
storing information about the optimal offset in a bitstream of the encoded video.

5. The video encoding method of claim 4, wherein a portion that is not included in the input video among the macroblocks spaced apart from the input video by the predetermined offset is formed by symmetrizing a portion of the input video which is not included in the macroblocks spaced apart from the input video by the predetermined offset.

6. The video encoding method of claim 4, wherein a portion that is not included in the input video among the macroblocks spaced apart from the input video by the predetermined offset is formed by extrapolating its neighboring pixels in the input video.

7. A video encoding method comprising:
dividing an input video into a plurality of predetermined-size blocks;
performing interprediction and intraprediction on each of the blocks to determine a prediction mode for each of the blocks;
grouping the blocks into at least one block group based on the determined prediction modes of the blocks; and
generating group map information including information about the determined prediction modes of the blocks included in the block groups.

8. The video encoding method of claim 7, wherein each of the block groups includes as many blocks having the same prediction mode as possible.

9. A video encoder comprising:
a video division unit which divides an input video while moving macroblocks in at least one of each row and each column by a predetermined-size pixel;
an encoding unit which encodes the video divided by the macroblocks;
an optimal moving position determination unit which compares costs of the encoded video according to moving positions of the macroblocks and determines an optimal moving position having a smallest cost for the macroblocks in the at least one of each row and each column; and
a position storage unit which stores information about the optimal moving position for the macroblocks in the at least one of each row and each column in a bitstream of the encoded video.

10. The video encoder of claim 9, wherein the video division unit horizontally moves the macroblocks in each row by the predetermined-size pixel and vertically moves the macroblocks in each column by the predetermined-size pixel.

11. A video encoder comprising:
an offset video division unit which divides an input video into macroblocks at a position spaced apart from a corner of the input video by a predetermined offset;
an encoding unit which encodes the video divided by the macroblocks spaced apart from the input video by the predetermined offset;
an optimal offset determination unit which compares costs of the encoded video according to values of the predetermined offset and determines an optimal offset having a smallest cost; and
an offset storage unit which stores information about the optimal offset in a bitstream of the encoded video.

12. The video encoder of claim 11, wherein the encoding unit performs encoding that forms a portion that is not included in the input video among the macroblocks spaced apart from the input video by the predetermined offset by symmetrizing a portion of the input video which is not included in the macroblocks spaced apart from the input video by the predetermined offset.

13. The video encoder of claim 11, wherein the encoding unit performs encoding that forms a portion that is not included in the input video among the macroblocks spaced apart from the input video by the predetermined offset by extrapolating its pixels neighboring the portion in the input video.

14. A video encoder comprising:
an encoding unit which divides an input video into a plurality of predetermined-size blocks and performs interprediction and intraprediction on each of the blocks to determine a prediction mode for each of the blocks;
a grouping unit which groups the blocks into at least one block group based on the prediction modes of the blocks; and
a group map information generation unit which generates group map information including information about the prediction modes of the blocks included in the block groups.

15. The video encoder of claim 14, wherein the grouping unit groups the blocks such that each of the block groups includes as many blocks having the same prediction mode as possible.

16. A video decoding method comprising:
receiving a bitstream including video data obtained by encoding a video divided while moving macroblocks in at least one of each row and each column by a predetermined pixel and moving position information of the macroblocks in the at least one of each row and each column;
decoding the video using the received video data; and
reconstructing the decoded video by moving the macroblocks in the at least one of each row and each column according to the received moving position information.

17. A video decoding method comprising:
receiving a bitstream including information about a predetermined offset and video data obtained by encoding a video divided into macroblocks at a position spaced apart from a corner of the video by the predetermined offset;
decoding the video using the received video data; and
reconstructing the decoded video by moving the decoded video according to the information about the predetermined offset.

18. A video decoding method comprising:
receiving a bitstream including video data obtained by encoding a video through interprediction or intraprediction with respect to each of a plurality of predetermined-size blocks and group information including information about the prediction modes of blocks included in a block group according to the prediction modes of the blocks; and
decoding the blocks according to the prediction modes of the blocks of the block group using the received group map information.

19. A video decoder comprising:
a receiving unit which receives a bitstream including video data obtained by encoding a video divided while moving macroblocks in at least one of each row and each column by a predetermined pixel and moving position information of the macroblocks in the at least one of each row and each column;
a decoding unit which decodes the video using the received video data; and
a video reconstruction unit which reconstructs the decoded video by moving the macroblocks in the at least one of each row and each column according to the received moving position information.

20. A video decoder comprising:
a receiving unit which receives a bitstream including information about a predetermined offset and video data obtained by encoding a video divided into macroblocks at a position spaced apart from a corner of the video by the predetermined offset;
a decoding unit which decodes the video using the received video data; and
a video reconstruction unit which reconstructs the decoded video by moving the decoded video according to the information about the predetermined offset.

21. A video decoder comprising:
a receiving unit which receives a bitstream including video data obtained by encoding a video through interprediction or intraprediction with respect to each of a plurality of predetermined-size blocks and group information including information about the prediction modes of blocks included in a block group according to the prediction modes of the blocks; and
a decoding unit which decodes the blocks according to the prediction modes of the blocks of the block group using the received group map information.

22. A computer-readable medium having stored therein a program for making a computer execute a video encoding process, said program including computer executable instructions comprising:
dividing an input video while moving macroblocks in at least one of each row and each column by a predetermined-size pixel;
encoding the video divided by the macroblocks;
comparing costs of the encoded video according to moving positions of the macroblocks;
determining an optimal moving position having a smallest cost for the macroblocks in the at least one of each row and each column; and
storing information about the optimal moving position for the macroblocks in the at least one of each row and each column in a bitstream of the encoded video.

23. The program of claim 22 wherein the moving the macroblocks further comprises moving the macroblocks in each row horizontally by the predetermined-size pixel and moving the macroblocks in each column vertically by the predetermined-size pixel.

24. The program of claim 22 further comprising comparing the cost of the video encoded using the moved macroblocks and the cost of a video encoded without moving the macroblocks and determining an encoding mode having the smaller cost as a final encoding mode.

25. A computer-readable medium having stored therein a program for making a computer execute a video encoding process, said program including computer executable instructions comprising:
dividing an input video into macroblocks at a position spaced apart from a corner of the input video by a predetermined offset;
encoding the input video divided by the macroblocks spaced apart from the input video by the predetermined offset;
comparing costs of the encoded video according to values of the predetermined offset and determining an optimal offset having a smallest cost; and
storing information about the optimal offset in a bitstream of the encoded video.

26. The program of claim 25 further comprising forming a portion that is not included in the input video among the macroblocks spaced apart from the input video by the predetermined offset by symmetrizing a portion of the input video which is not included in the macroblocks spaced apart from the input video by the predetermined offset.

27. The program of claim 25 further comprising forming a portion that is not included in the input video among the macroblocks spaced apart from the input video by the predetermined offset by extrapolating its neighboring pixels in the input video.

28. A computer-readable medium having stored therein a program for making a computer execute a video encoding process, said program including computer executable instructions comprising:
dividing an input video into a plurality of predetermined-size blocks;
performing interprediction and intraprediction on each of the blocks to determine a prediction mode for each of the blocks;
grouping the blocks into at least one block group based on the determined prediction modes of the blocks; and
generating group map information including information about the determined prediction modes of the blocks included in the block groups.

29. The program of claim 28, wherein the grouping the blocks further comprises including as many blocks having the same prediction mode as possible in each of the block groups.

30. A computer-readable medium having stored therein a program for making a computer execute a video decoding process, said program including computer executable instructions comprising:
receiving a bitstream including video data obtained by encoding a video divided while moving macroblocks in at least one of each row and each column by a predetermined pixel and moving position information of the macroblocks in the at least one of each row and each column;
decoding the video using the received video data; and
reconstructing the decoded video by moving the macroblocks in the at least one of each row and each column according to the received moving position information.

31. A computer-readable medium having stored therein a program for making a computer execute a video decoding process, said program including computer executable instructions comprising:
receiving a bitstream including information about a predetermined offset and video data obtained by encoding a video divided into macroblocks at a position spaced apart from a corner of the video by the predetermined offset;
decoding the video using the received video data; and
reconstructing the decoded video by moving the decoded video according to the information about the predetermined offset.

32. A computer-readable medium having stored therein a program for making a computer execute a video decoding process, said program including computer executable instructions comprising:
receiving a bitstream including video data obtained by encoding a video through interprediction or intraprediction with respect to each of a plurality of predetermined-size blocks and group information including information about the prediction modes of blocks included in a block group according to the prediction modes of the blocks; and
decoding the blocks according to the prediction modes of the blocks of the block group using the received group map information.
